(19) United States
(12) Patent Application Publication
(10) Pub. No.: US 2005/0023086 A1
(43) Pub. Date: Feb. 3, 2005

(54) Shape memory alloy-actuated and bender-actuated helical spring brakes

(76) Inventor: Andrei Szilagyi, Danville, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/882,786

(22) Filed: Jun. 30, 2004

Related U.S. Application Data
(60) Provisional application No. 60/484,021, filed on Jun. 30, 2003.

(51) Int. Cl. B65H 59/10; F16D 55/02

(52) U.S. Cl. 188/67

(57) ABSTRACT

In one embodiment of the present invention, a shape memory alloy (“SMA”)-actuated helical spring brake comprises a rotatable member and a helical wrap spring arranged concentrically about the rotatable member. The spring has a first spring end and a second spring end and includes a number of turns that are based radially inward and are configured to frictionally engage the rotatable member. The turns permit rotation of the rotatable member in a first direction and inhabit rotation in a second direction. The SMA-actuate helical spring brake also include an anchor point coupled to the second spring end, and an SMA actuator having an output drive member coupled to the first spring end. The SMA actuator is configured to, for example, deflect the first spring end to permit the rotatable member to rotate.

### CROSS REFERENCE TO A RELATED APPLICATION

This application claims benefit under 35 U.S.C. 119(e) of United States Provisional Patent Application Number 60/484,021 filed Jun. 30, 2003 entitled “SMA-Actuated Helical Spring Brake,” the disclosure of which is incorporated herein by reference in its entirety.

### FIELD OF THE INVENTION

The present invention relates generally to braking systems, and in particular, to shape memory alloy (“SMA”)-actuated and to bender-actuated helical brake mechanisms for permitting and inhibiting movement of one or more members relative to each other.

### BACKGROUND OF THE INVENTION

Helical wrap springs are commonly employed in conventional braking mechanisms to control whether two or more moveable members can move relative to each other. In a typical helical spring brake, a helical wrap spring is positioned concentrically about, and in frictional engagement with, the outer surface of a drive member, such as a shaft or drum. The direction of the turns of the helical wrap spring permits rotation of the shaft in one direction relative to the spring (i.e., in a direction that tends to unwrap the helically coiled spring), but those same turns also prevent rotation of the shaft in the opposite direction (i.e., in a direction that tends to wrap the helically coiled spring). By externally applying an expansion or separation force to the ends of the spring, the spring operates frictionlessly, or nearly frictionlessly, with respect to the shaft. As such, the shaft is released to freely rotate in either direction relative to the spring.

Traditionally, actuation mechanisms that expand or separate the spring ends typically rely on a collection of sophisticated linkages (e.g., cables or rods), gears or other relatively complicated mechanical configurations. There are at least as many types of actuation mechanisms for initiating or terminating braking as there are applications for helical spring brakes. Some examples of applications employing helical spring brakes include automobiles, bicycles, elevators, hoists, as well as adjustment mechanisms for window regulators, window shades, car seats, seat head rests, and the like.

But the conventional actuation mechanisms used to activate braking in these applications, although adequate in operation, are typically associated with one or more of the following drawbacks. A first drawback is that conventional actuation mechanisms usually require either numerous quantities of members (e.g., a number of gears) or large-sized members (e.g., elongated activator members, such as rods or cables), or both, to effectuate actuation. As such, conventional actuators for helical wrap spring brakes are generally suboptimal in form factor (i.e., in physical, external dimensions) as well as in simplicity. As an example, consider that window lifters using a helical spring brake are well known in the art to inhibit unintentional motion of the lifting mechanism (and the window). To inhibit the unintentional motion of a payload (i.e., an object being acted upon, such as a window), lifting mechanisms rely on complex configurations using one or more of the following: a set of gears; concentric drums in which an internal helical wrap spring unwinds from a first drum to engage frictionally with the inner surface of a second drum, which is hollow and co-axial with the first; multiple springs for all directions of travel; a relatively heavy motor having enough friction in its off state so that the payload will remain stationary (such heavy motors typically consume more power than is otherwise necessary); and a pin-like latch for locking a part used to lift a payload, the unlocking of which requires an actuator powerful enough to disengage the pin from the locked part as the weight of the payload (e.g., a window) bears down on the pin.

Other drawbacks of current helical spring brake actuators are that the use of linkages and gears tend to either limit the placement of a trigger for the actuator or require sufficient physical dexterity by users to trigger actuation (i.e., by manually separating the spring ends), or both. As such, manual separation of the spring ends can be difficult for elderly or otherwise infirm users. For example, automobile parking brakes or hood latches employing helical spring brakes generally require substantial effort to release the helical wrap spring. Moreover, the triggering means to release parking brakes and hood latches, such as a knob, are inconveniently located underneath the steering wheel and dashboard.

As another example, consider that helical wrap spring actuation mechanisms for seat reclination applications (as well as other applications) typically employ a number of gears or linkages for activating a helical spring brake, which tends to be off-axis to the gears or linkages. This arrangement increases the number of components constituting the actuation mechanism. As with parking brakes and hood latches, a triggering means is used to either recline a seat back or to move the seat forward to enable persons to enter or exit a back seat. An example of such a triggering means is a manual seat latch, which is inconveniently located at the bottom of a seat back, near the floor of a vehicle. So, conventional actuation mechanisms generally limit designers from placing the triggering means in a convenient location. Another drawback is that the mechanical linkages and gears that traditionally constitute these actuators can inadvertently generate audible sounds, as noise, from the interaction of the actuator components.

In view of the foregoing, what is needed is an improved actuation mechanism for operating helical spring brakes to overcome the drawbacks of conventional actuators.

### SUMMARY OF THE INVENTION

In one embodiment of the present invention, a shape memory alloy (“SMA”)-actuated helical spring brake comprises a rotatable member and a helical wrap spring arranged concentrically about the rotatable member. The spring has a first spring end and a second spring end and it includes a number of turns configured to frictionally engage the rotatable member by means of an inwardly-directed radial bias. The turns permit rotation of the rotatable member in a first direction and inhibit rotation in a second direction. The SMA-actuate helical spring brake also includes an anchor point coupled to the second spring end, and an SMA actuator having an output drive member coupled to the first spring end. The SMA actuator is configured to, for example, deflect the first spring end to permit the rotatable member to rotate. The rotatable member is typically a shaft.

In a related embodiment, the SMA-actuated helical spring brake can include a motor rigidly coupled to the rotatable member for providing a motive torque to rotate the rotatable member. The SMA-actuated helical spring brake can also include a payload rigidly coupled to the rotatable member. In some cases, the payload exerts a bias torque sufficient to rotate the rotatable member in the second direction when the helical wrap spring permits the rotatable member to rotate. As such, this SMA-actuated helical spring brake is suitable to operate on a payload that is a window. In another embodiment, the SMA-actuated helical spring brake further comprises a biasing device configured to induce rotation of the rotatable member in the second direction when the helical wrap spring permits the rotatable member to rotate. Consequently, an SMA-actuated helical spring brake with a biasing device is suitable to operate on a pin-latch mechanism, a door opening mechanism or a seat back safety lock release mechanism. In some embodiments of the present invention, a bender actuator is substituted for an SMA actuator to govern actuation of a helical spring brake.

### BRIEF DESCRIPTION OF THE DRAWINGS

The invention is more fully appreciated in connection with the following detailed description taken in conjunction with the accompanying drawings, in which:

FIG. 1 depicts a shape memory alloy (“SMA”)-actuated helical spring brake, according to one embodiment of the present invention;

FIGS. 2A and 2B respectively depict a deflection detector and a rotation detector for controlling SMA-actuated helical spring brakes, according to one embodiment of the present invention;

FIG. 3 depicts a helical spring brake employing an energy storage device as a bias force in accordance with an embodiment of the present invention;

FIG. 4 illustrates an implementation of an SMA-actuated helical spring brake of FIG. 1 in a window lifting mechanism, according to one embodiment of the present invention;

FIGS. 5 and 6 are axial views illustrating an implementation of the SMA-actuated helical spring brake of FIG. 3 in a pin-latch release mechanism, according to an embodiment of the present invention;

FIG. 7 illustrates another implementation of an SMA-actuated helical spring brake of FIG. 3 in a door mechanism, according to at least one embodiment of the present invention;

FIG. 8 is a functional block diagram of a vehicle seat back release mechanism implementing an SMA-actuated helical spring brake in accordance with an embodiment of the present invention; and

FIGS. 9A to 9C illustrate a bender-actuated helical spring brake in accordance with an embodiment of the present invention.

Like reference numerals refer to corresponding parts throughout the several views of the drawings.

### DETAILED DESCRIPTION OF EXEMPLARY EMBODIMENTS

Embodiments of the present invention relate to SMA-actuated and bender-actuated helical spring brakes for imparting motion to a payload. According to some embodiments of the invention, an SMA-actuated helical spring brake can be configured to permit or inhibit a rotatable member to move a payload, such as window, a seat back, etc. Advantageously, an SMA-actuated helical spring brake according to some embodiments of the present invention can be formed with a relatively compact form factor so as to preserve space that otherwise would be consumed by sophisticated linkages, gears or other relatively complicated mechanical configurations. As such, embodiments of the present invention facilitate the miniaturization of helical spring brake actuator mechanisms. Without the need for physical efforts to release a helical spring brake in accordance to some embodiments, SMA-actuated helical spring brakes facilitate actuation for elderly and infirm users. Also, an SMA-actuated helical spring brake according to some embodiments of the present invention can be triggered remotely without requiring mechanical linkages from the site of remote activation to the brake, thus allowing convenient placement of a trigger for activating SMA-actuated helical spring brakes. Moreover, an SMA-actuated helical spring brake according to some embodiments of the present invention can include a deflection detector or a rotation detector to reduce the amount of time that an SMA actuator remains activated, thus increasing the life expectancy of the SMA actuator.

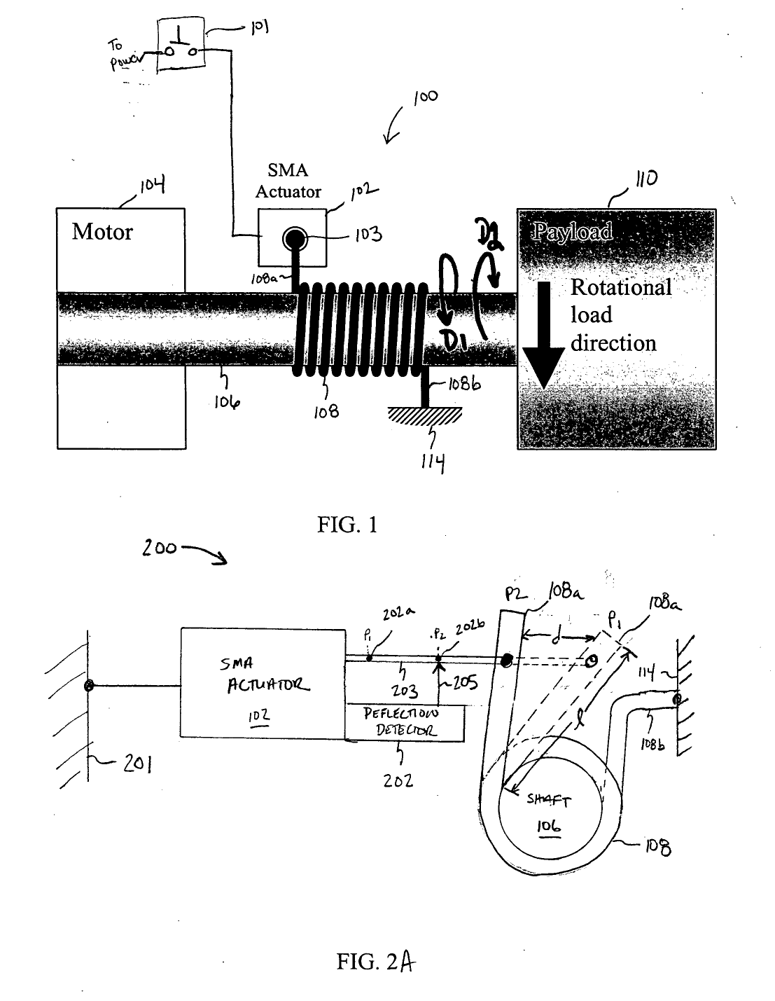

FIG. 1 depicts a shape memory alloy (“SMA”)-actuated helical spring brake 100, according to one embodiment of the present invention. Helical spring brake 100 includes an SMA actuator 102, a helical wrap spring 108 and an immovable anchor point 114 for permitting or inhibiting rotation of a shaft 106. SMA actuator 102 is coupled to helical wrap spring 108 at spring end (or tang) 108a for controlling whether helical wrap spring 108 frictionally engages shaft 106 to govern the rotational motion of shaft 106. Further, helical wrap spring 108 is coupled to anchor point 114 at another spring end 108b. Also, shaft 106 is rigidly coupled to a motor 104 and a payload 110.

A trigger 101 is configured to trigger activation of SMA actuator 102, which in turn releases helical spring brake 100. Trigger 101, such as a push-button, can be located at a location convenient to a user without regard to linkages, gears, or some other mechanical member extending from trigger 101 to SMA-actuated helical brake, as typically required by conventional helical wrap spring actuation mechanisms. Trigger 101 generates an electrical signal that causes SMA actuator 102 to activate.

SMA actuator 102 can be of any configuration that uses one or more SMA elements as the primary force generation means. An SMA “element” refers to an SMA material of elongate form, capable of contraction and elongation along the longitudinal axis. The element may have a circular cross-section, as is the case for an SMA wire, or any of a variety of cross-sections such as elliptical, square, rectangular, or the like. Shape memory alloy (“SMA”) refers to metals, which exhibit two very unique properties, pseudo-elasticity, and the shape memory effect. Pseudo-elasticity refers to the almost rubber-like flexibility of SMAs. The shape memory effect refers to the unique ability of shape memory alloys to be severely deformed and then returned to their original shape simply by heating them. By way of example and not limitation, shape memory alloys include NiTi (Nickel-Titanium), CuZnAl, and CuAlNi among others. Although other means are known in the art, heating is commonly accomplished by passing an electric current through the wire. For purposes of concreteness, the description of the present invention invokes mainly electric or ohmic heating of the SMA wire.

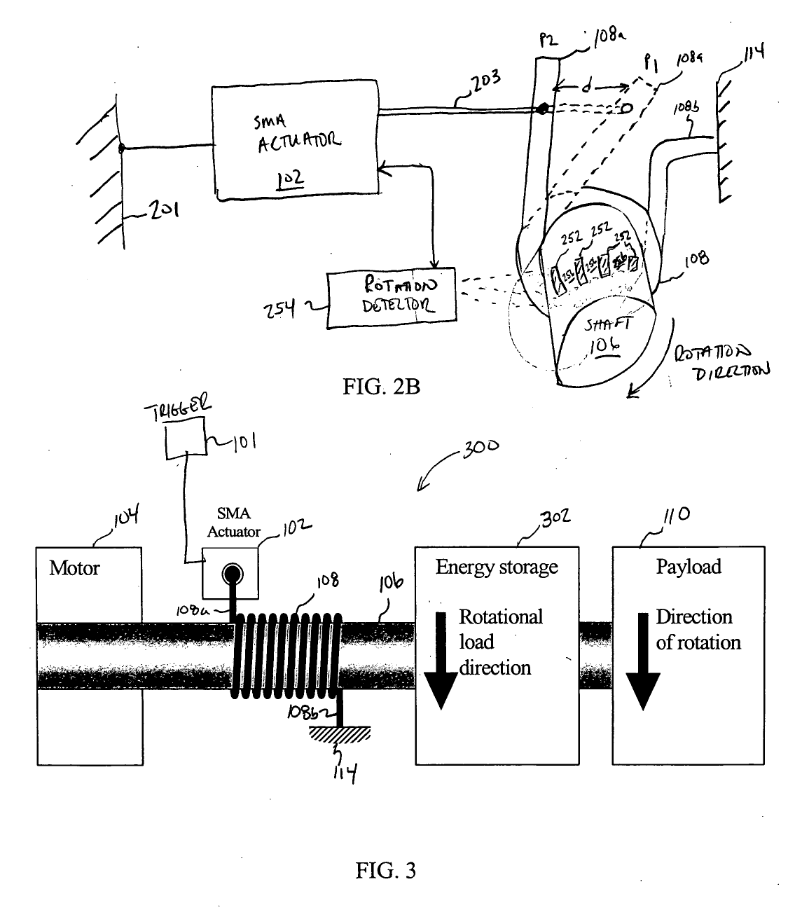

To effectuate actuation of SMA actuator 102, its SMA elements (e.g., SMA wires) are heated by passing a current through the elements, causing an output drive member 103 of SMA actuator 102 to retract. Output drive member 103 is typically a plate, rod, or some other member configurable to drive a load upon which SMA actuator 102 operates. A perspective view of output driver member 103 is shown in FIGS. 2A and 2B as output drive member 203. By contrast, when the SMA elements of SMA actuator 102 are cooled, SMA actuator 102 and its output drive member 103 can return to its extended state. The return to the extended state may be accomplished by a number of methods. In FIG. 1, it is accomplished by using the resilience of helical wrap spring 108 and its spring ends 108a and 108b to create a spring bias. Alternatively, another spring may be added to increase the bias force by cooperating with the bias of helical wrap spring 108. Yet another alternative results when another actuator is used to extend SMA actuator 102. The another actuator may itself be based on SMA elements or maybe of a completely different nature. Without undue effort, an ordinarily skilled artisan should appreciate that SMA actuator 102 can be designed to drive a wide range of loads. That is, SMA actuator 102 can be adapted to be able to move the spring ends of most types of helical wrap springs (e.g., from light-duty springs to heavy-duty springs). In accordance with a specific embodiment of the present invention, SMA actuator 102 can be a single or multiple-strand SMA wire, or it can be any actuator disclosed in U.S. Pat. No. 6,574,958 having a title “Shape Memory Alloy Actuators and Control Methods,” which is incorporated herein by reference in its entirety. That patent was filed on Aug. 11, 2000 and is assigned to NanoMuscle, Inc.

Motor 104 is a drive mechanism for rotating shaft 106. The drive mechanism can operate by converting electrical energy, mechanical energy, thermal energy, or some other type of energy into mechanical energy for imparting a rotational force upon shaft 106. In some embodiments, motor 104 operates to turn shaft 106 in one direction of rotation while payload 110 tends to cause shaft rotation in the other direction. In some cases, motor 104 can be a motive force provided by a human being (i.e., a person causes rotation of shaft 106). Payload 110 is the object that helical spring brake 100 operates upon via shaft 106 to either permit that object to move or to inhibit its motion. Examples of such objects include windows, window regulators, window shades, car seats, seat head-rests, latches, vehicle power door locks, power glove-box locks, gas-tank flaps, trunk lids, or any other type of object where it is desirable to control the motion of that object. In some cases, payload 110 provides its own bias force that biases rotation of shaft 106 in direction D1. For example, if payload 110 is a window, gravity acting on the mass of the window is the bias force for that window.

Helical wrap spring 108 is configured to maintain frictional engagement with shaft 106 when spring end 108a is not being acted upon by SMA actuator 102. Specifically, when SMA actuator 102 is in its extended state (i.e., inactive or unpowered), helical wrap spring 108 remains firmly wrapped in a direction around shaft 106 such that if the bias of payload 110 causes rotation of shaft 106, the frictional engagement between shaft 106 and helical wrap spring 108 strengthened. As such, payload 110 cannot rotate in direction “D1.” But when SMA actuator 102 is in its contracted state (e.g., when it is triggered or activated by a user), output drive member 103 of SMA actuator 102 acts upon spring end 108a to deflect it by an amount that tends to unwrap spring 108 from shaft 106. This deflection permits helical wrap spring 108 to operate in frictionless engagement with shaft 106 so that shaft 106 is free to rotate in either direction “D1” or “D2.”

In accordance with various embodiments of the present invention, helical spring brake 100 provides a braking mechanism regardless of whether motor 104 is found in any of three states. In a first state, motor 104 is unpowered and does not engage or rotate shaft 106. In a second state, motor 104 is configured to rotate shaft 106 against the bias of payload 110. And in a third state, motor 104 is configured to rotate shaft 106 in the same direction as the bias of payload 110.

In the first state, consider that motor 104 and SMA actuator 102 are both inactive. In this state, the bias of payload 110 can cause shaft 106 to begin rotating if helical wrap spring 108 is not sufficiently engaged with shaft 106. Because of the orientation of the wrapped turns of helical wrap spring 108, friction between shaft 106 and helical wrap spring 108 acts to wind the latter more tightly around the former until rotational movement of shaft 106 ceases completely. Helical wrap spring 108 can be configured so that its winding about shaft 106 is almost imperceptible and its response time is almost instantaneous when braking has been initiated.

In the second state, consider that SMA actuator 102 is inactive (i.e., in an extended and slack state) and motor 104 is active or powered to rotate shaft 106. Motor 104 drives shaft 106 to slightly unwind helical wrap spring 108 in direction D2, thereby significantly reducing the friction between shaft 106 and helical wrap spring 108. Thereafter, the load presented to motor 104 is primarily that of payload 110. So to rotate shaft 106 in direction D2, the torque output of motor 104 should exceed the torque load of payload 110. Once the torque generated by motor 104 surpasses that of the torque load of payload 110 by an amount at least equal to the residual frictional torque of helical wrap spring 108 about shaft 106, shaft 106 rotates in direction D2. For example, consider that payload 110 is a window. Once motor 104 generates enough torque to overcome the weight of the window (as a bias) and the slight residual friction of helical wrap spring 108, the window will move from a rolled-down position to a rolled-up position.

In the third state, consider that SMA actuator 102 is active and in a state of contraction, whereas motor 104 is inactive (i.e., unpowered). In this state, SMA actuator 102 moves spring end 108a in an unwinding direction. This movement causes the frictional force exerted by helical wrap spring 108 on shaft 106 to be significantly reduced. If the bias of payload 110 is sufficient to overcome other frictional torques of the system (e.g., that of an unpowered motor 104), then shaft 106 rotates in direction D1. Continuing with the previous example, the weight of the window as payload 110 causes the window to move from a rolled-up position to a rolled-down position. In some embodiments, motor 104 can be activated in this state to urge movement of payload 110 if the bias of payload 110 is insufficient to overcome the frictional forces in the system or if greater speed is desired.

FIGS. 2A and 2B respectively depict a deflection detector and a rotation detector for controlling SMA-actuated helical spring brakes, according to embodiments of the present invention. FIG. 2A shows an exemplary helical spring brake 200 including SMA actuator 102 and deflection detector 202 for controlling deflection of helical wrap spring 108. SMA actuator 102 is affixed to an immovable anchor point 201 so that output drive member 203 of SMA actuator 102 can drive spring end 108a. Output drive member 203 of SMA actuator 102 can be an extension rod or any other coupling element suitable to pull (or push) spring end 108a to deflect that end by a distance, “d.” In one embodiment, the length “l,” of spring end 108a is adapted to provide an appropriate amount of leverage so that an SMA-based actuator, such as SMA actuator 102, can actuate helical spring brake 200.

Deflection detector 202 is communicatively coupled to SMA actuator 102, and is configured to detect when spring end 108a deflects by the distance, d, from a first position, “P1,” to a second position, “P2.” Position P1 indicates the position of spring end 108a at which helical wrap spring 108 frictionally engages shaft 106 to inhibit rotation, whereas position P2 indicates the position of spring end 108a at which shaft 106 freely rotates. Deflection detector 202 can include a wiper 205 configured to maintain contact with output drive member 203 as it retracts and extends. Wiper 205 sends a signal indicating contact with either point 202a or point 202b. Point 202a is coincident with the beginning of travel for output drive member 203 as well as position P1, and point 202b is coincident with the end of travel for output drive member 203 as well as position P2. Given this, deflection detector 202 permits SMA actuator 102 to operate between a beginning and an end of travel respectively coincident with position P1 and position P2.

In operation, spring end 108a typically starts at position P1. Deflection detector 202 will indicate this position to SMA actuator 102. When a user triggers SMA actuator 102, output drive member 203 moves spring end 108a to position P2 as SMA actuator 102 contracts. A suitable trigger can be a push button conveniently accessible to a user, or the trigger can be any other mechanism for closing an electrical circuit so that current will pass through the SMA elements of SMA actuator 102. When deflection detector 202 detects point 202b (i.e., end of travel has been reached, spring end 108a is at position P2), then SMA actuator 202 powers down its SMA wires so as not to overheat them. A suitable circuit for practicing one embodiment of deflection detector 202 in accordance with the present invention is disclosed in U.S. patent application Ser. No. 10/080,640, titled “SMA Actuator with Improved Temperature Control” and filed on Feb. 21, 2002, the disclosure of which is incorporated herein by reference in its entirety. In some embodiments, SMA-actuator 102 powers its SMA elements for a duration of time necessary to deflect spring end 108a from P1 to P2, after which deflection detector 202 powers down those SMA elements. So, even if an obstruction hinders deflection of spring end 108a, the SMA wires of SMA actuator 102 will not overheat.

In some embodiments, an end-of-travel switch may be conveniently located to detect the movement of the actual payload. Specifically, an end-of-travel having a similar structure to deflection detector can operate to detect a position indicating the end of movement for a payload. In the case of a window lifter mechanism, for instance, such a switch might detect the arrival of the window to its fully lowered position. Also, a power circuit (not shown) can be configured using conventional design techniques to disable its power so that any further triggering (e.g., push-button depression) at trigger 101 by a user will not cause any additional power to flow to the SMA actuator, thereby preserving the longevity of the SMA elements of SMA actuator 102, among other things.

FIG. 2B is another exemplary helical spring brake 250 in accordance with a specific embodiment of the present invention. Helical spring brake 250 includes a rotation detector 254 for controlling operation of SMA actuator 102. Rotation detector 254 operates to control the powering of SMA elements to either extend or retract output drive member 203 based on whether shaft 106 is rotating, rather than based on an amount of deflection of spring end 108a. SMA actuator 102 is coupled to rotation detector 254, which is configured to detect whether shaft 106 is rotating, and in some cases, the rate at which shaft 106 is rotating. In this example, rotation detector is an optical detector that transmits light and receives light reflected from reflective surfaces 252, each of which can be reflective tape located equidistant around the outer surface of shaft 106. Since gaps 256 do not reflect light, rotation detector 254 can detect that shaft 106 is rotating when either reflected light received at a first point in time fades in intensity as the transmitted light becomes incident on a gap 256 at a second point of time, or vice versa.

After SMA actuator 102 is triggered to release helical wrap spring 108, output drive member 203 begins retracting to deflect spring end 108a from position P1 to position P2. In one embodiment, SMA actuator 102 deflects spring end 108a relatively quickly so shaft 106 begins rotating expeditiously. Rotation detector 254 detects rotation of shaft 106 and permits SMA actuator 102 to continue operation, without regard to the rate of rotation, until shaft 106 stops rotating. Once rotation detector 254 detects no rotation, it will disable current from being applied through the SMA elements. As shaft 106 rotates in the other direction, rotation detector 254 is configured to determine whether SMA actuator 102 was powered before rotation begins. If it was not powered before shaft 106 begins rotation, then rotation detector 254 refrains from powering the SMA elements of SMA actuator 102. This means the shaft is rotating in a direction opposite than before. In another embodiment, rotation detector 254 is configured to detect a specific rate of rotation (or a range of rates of rotation) and modulates the passage of current into SMA actuator 102 to maintain shaft 106 rotating at a desired rate of rotation, until shaft 106 ceases rotation. A variety of other sensors and signals may also be configured to control the flow of power to the SMA actuator. For instance, a window lift end-of-travel switch may work in conjunction with rotation detector 254. In this case, if the rotation stops before the end-of-travel switch is triggered, an unsafe condition may be inferred (such as due to a trapped human limb), and power to the motor may be interrupted to curtail the unsafe situation. A similar condition may be concluded based of reading the signal from a load cell mechanically placed in series between the motor and the window.

FIG. 3 depicts a helical spring brake 300 employing an energy storage device 302, according to one embodiment of the present invention. Helical spring brake 300 is suitable to implement in applications where payload 110 is not sufficiently biased, for example, by its own weight (i.e., its mass under influence of gravity). Without such a bias, helical spring brake 300 requires an external energy storage device 302 to bias shaft 106 in a direction of rotation so that shaft 106 will rotate when helical wrap spring 108 is unwound. Examples of energy storage device 302 are an extension spring, a torsion spring, or some other type of mechanism capable of applying a bias to shaft 106.

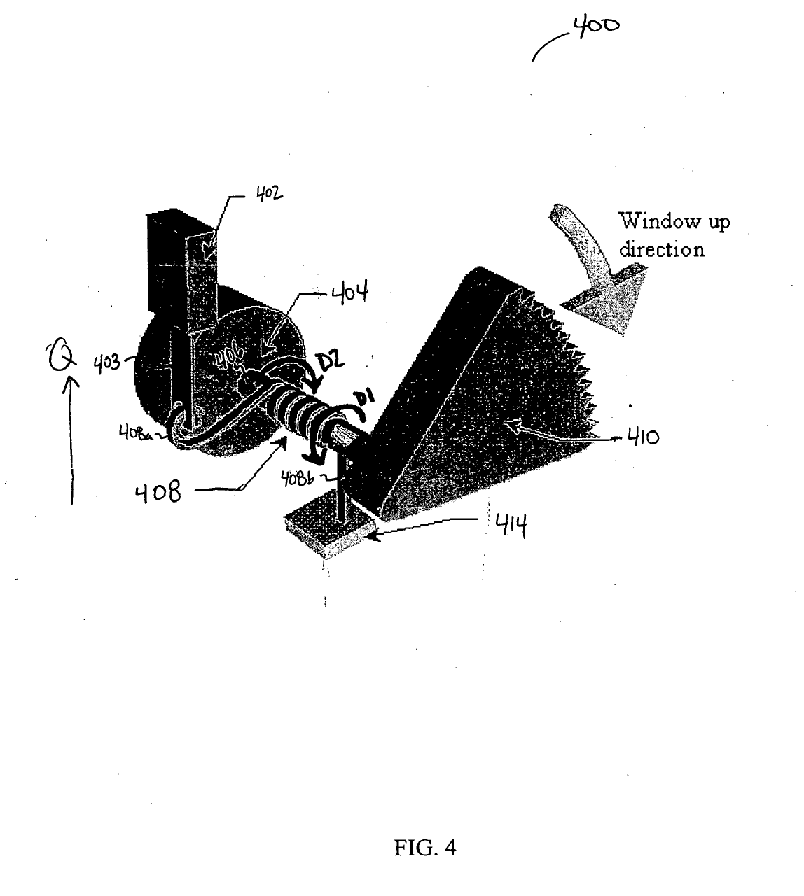

FIG. 4 illustrates an implementation of helical spring brake 100 of FIG. 1 in a window lifting mechanism, according to an embodiment of the present invention. Window lifting mechanism 400 includes a helical spring brake composed of SMA actuator 402, helical wrap spring 408 an anchor point 414. The helical spring brake is configured to prevent a window (not shown) from back-driving window lifter member 410 due to the bias of the window. As such, the helical spring brake provides a braked window lifter mechanism 400, wherein the brake is responsive to a relatively small, light, inexpensive and reliable actuator based on the principles of shape memory alloy (“SMA”) actuation. Window lifting mechanism 400 is relatively simple in its construction and can effectuate large changes in frictional force induced by relatively small movements of actuated spring end 408a.

Window lifting mechanism 400 operates as follows. When SMA actuator 402 is inactive with its output drive member 403 extended and slack, helical wrap spring 408 is an frictional engagement with shaft 406. Helical wrap spring 408 is coupled at spring end 408a to output drive member 403 and is coupled at spring end 408b to anchor point 414. With the direction of the wrapped turns of helical wrap spring 408 shown in FIG. 4, shaft 406 is relatively free to rotate in direction D2 when driven by motor 404. As motor 404 rotates shaft 406 in direction D2, window lifter member 410 causes the window, as a payload, to move toward a rolled-up position. When motor 404 stops rotating shaft 406, the configuration of helical wrap spring 406 prevents shaft 406 from rotating in direction D1. But when SMA actuator 402 is triggered, or activated, then output drive member 403 moves in the direction of retraction, “Q,” as shown in FIG. 4, which in turn releases helical wrap spring 408. Optionally, motor 404 can be activated to rotate shaft 406 in direction D1 to lower the window toward a rolled-down position.

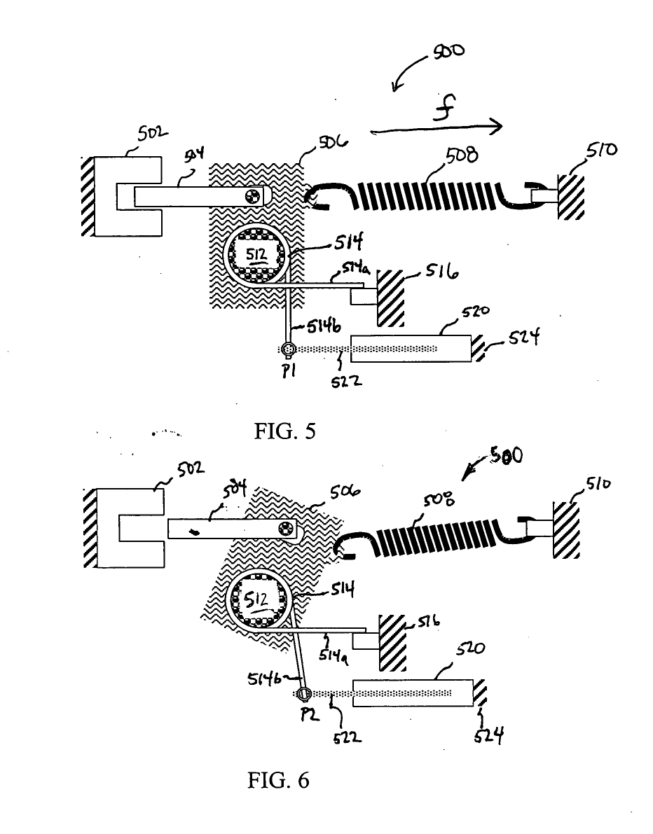

FIGS. 5 and 6 are axial views illustrating an implementation of helical spring brake 300 of FIG. 3 in a pin-latch release mechanism, according to embodiments of the present invention. FIG. 5 shows pin-latch release mechanism 500 implementing an SMA-actuated helical spring brake suitable for applications where a payload lacks sufficient bias to rotate shaft 512. Examples of suitable applications are security devices, such as door locks, furniture locks, automotive components, such as glove boxes, trunk lids, hood latches, parking brake releases, and many other types of uses. In the example shown in FIG. 5, a pin 504, as a payload, is engaged with a locking recess, or latch 502. The helical spring brake of pin-latch release mechanism 500 includes SMA actuator 520 affixed to an immovable anchor point 524, helical wrap spring 514, pin 504, a link member 506 and a bias device 508.

FIG. 5 depicts helical wrap spring 514 being frictionally engaged with shaft 512, and having a first spring end 514b coupled to output drive member 522 and a second spring end 514a immobilized by anchor point 516. Spring end 514b is in position P1 when SMA actuator 524 is inactive so that output drive member 522 remains extended. Further to FIG. 5, link member 506 is pivotally coupled to pin 504 and to bias device 508. Bias device 508 is shown as an extension spring having another end affixed to anchor point 510. Link member 506 is rigidly coupled to shaft 512 to rotate in the same direction and by the same amount as shaft 512. Extension spring 508 is extended so as to provide a bias force, “f,” toward anchor point 510 that is sufficient to rotate both link member 506 and shaft 512. But with helical wrap spring 514 wrapped in a manner around shaft 512 such that the bias force, f, pulls shaft 512 in a wrapping direction of helical wrap spring 514, shaft 512 maintains frictional engagement with helical wrap spring 514. This prevents pin 504 from disengaging latch 502.

FIG. 6 depicts pin-latch release mechanism 500 after SMA actuator 520 actuates to release the helical spring brake. Once SMA actuator is active, output drive member 522 retracts to move spring end 514b to position P2, which is in the unwind direction. At position P2, shaft 512 freely rotates along with link member 506. Under bias force, f, link member 506 rotates toward anchor point 510 thereby disengaging pin 504 from latch 502. As such, a first member (not shown) associated with latch 502, such as car hood, is moveable in relationship to a second member (not shown) associated with pin 504, such as a car frame. In some embodiments, a user provides a motive force (not shown) to rotate shaft 512 and to reextend extension spring 508 by manually moving (or by other means) the first member back into engagement with the second member, which concurrently stores potential energy in extension spring 508 for the next activation of SMA actuator 520.

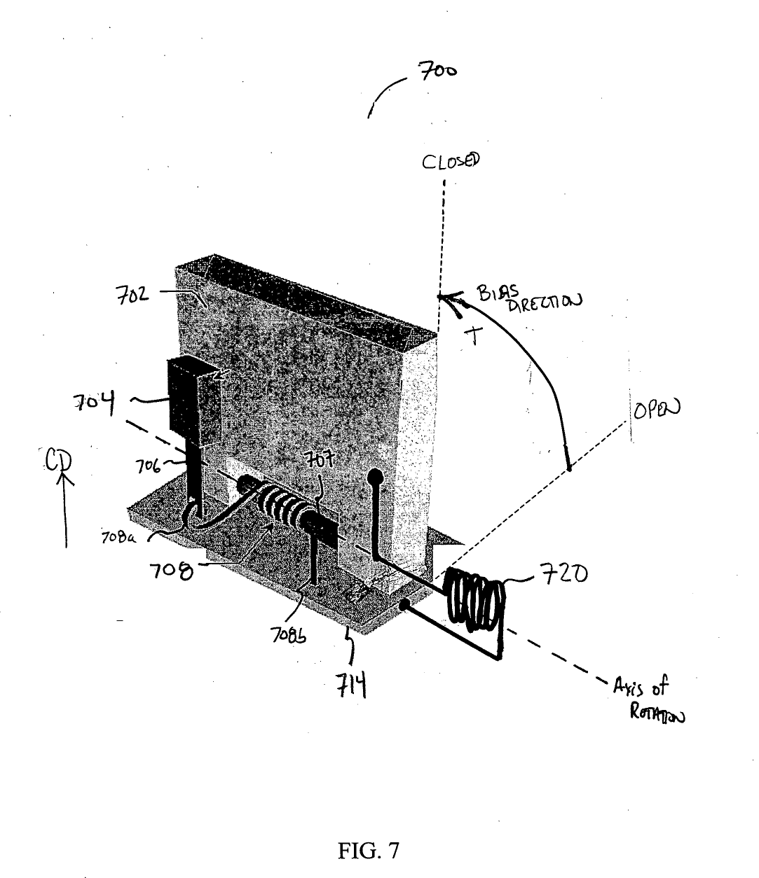

FIG. 7 illustrates another implementation of helical spring brake 300 of FIG. 3 in a door or lid moving mechanism, according to an embodiment of the present invention. FIG. 7 shows door-moving mechanism 700 having a payload that lacks sufficient bias to rotate shaft 707 of the SMA-actuated helical spring brake. In the example shown in FIG. 7, a door 702 (e.g., a glove box door) is the payload, a portion of which is shown in FIG. 7. The helical spring brake of door-moving mechanism 700 includes SMA actuator 704 affixed to an immovable anchor point (not shown), helical wrap spring 708, and a torsion spring 720 as a bias device. Helical wrap spring 708 is frictionally engaged with shaft 707, having a first spring end 708a coupled to output drive member 706 and a second spring end 708b immobilized by anchor point 714. Torsion spring 720, or its equivalent, is employed to provide a bias force, T, in the direction shown. When SMA actuator 704 is inactive and glove box door 702 is in its closed position, as shown schematically by a dashed line, helical wrap spring 708 precludes glove box door 702 from moving into its open position until SMA actuator 704 is energized. When activated, SMA actuator 704 causes output drive member 706 to retract in direction, “CD,” so as to unwrap spring end 708a. This permits shaft 707 to rotate glove box door 702 to its open position (shown in the figure) under the influence of torsion spring 720. As glove box door 702 is closed by a user from its open position, potential energy is once again stored in torsion spring 720 for future use. It should be noted that the positions designating an “open” position and a “closed” position can be interchanged. Door-moving mechanism 700 merely specifies an application that requires a bias assist torque be released at will, or remotely, to rotate a door-like object from one position to another. The two positions would then be described as corresponding to a charged and a discharged state of the energy storage component 302, as shown abstractly in FIG. 3.

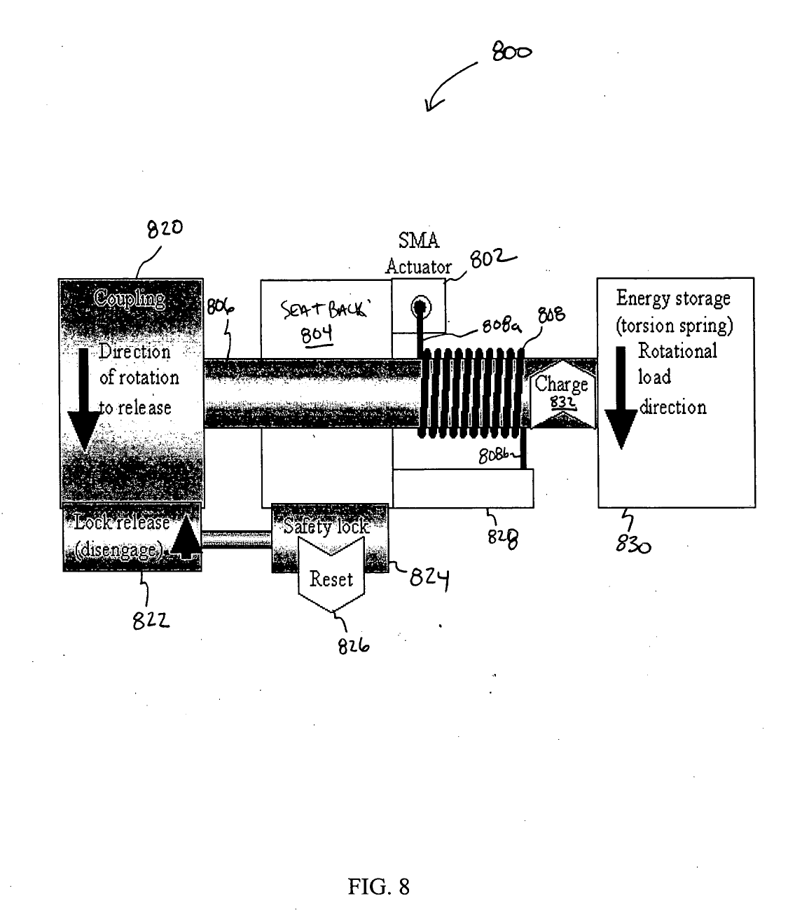

FIG. 8 is a functional block diagram of a vehicle seat back release mechanism implementing a helical spring brake in accordance with an embodiment of the present invention. In most vehicles, such as automobiles, some seats are designed to recline or to move (or tilt) forward to permit passengers to enter and exit a back seat. For safety reasons, automobile seats capable of tilting forward require safety interlocks capable of withstanding the likely disturbances encountered by automobiles that otherwise might cause inadvertent tilting or reclining in the event of sudden deceleration. In two-door cars, access to the back seat requires a front seat to easily adjust to a forward tilt position while being manipulated by a back-seat passenger. In accordance with the present invention, an SMA actuated-helical spring brake is implemented in a vehicle seat back release mechanism 800, and therefore, facilitates comfortable access to rear seating areas of a vehicle, especially for the increasing numbers of elderly and infirm passengers. Specifically, the seat back release can be a simple button that is conveniently located in a general area, such as on the back of a seat.

Vehicle seat back release mechanism 800 includes an SMA-actuated helical spring brake composed of SMA actuator 802, helical wrap spring 808 and anchor member 828. Helical wrap spring 808 frictionally engaged with shaft 806 when SMA actuator 802 is inactive, and has a first spring end 808a coupled to an output drive member of SMA actuator 802 and a second spring end 808b anchored at anchor member 828. SMA actuator 802 and anchor member 828 are rigidly coupled to seat back 804. Seat back 804 can be viewed as a motor that provides a motive torque to vehicle seat back release mechanism 800. A human hand typically applies the motive torque applied to seat back 804.

Shaft 806 is rigidly coupled to coupling 820 and energy storage device 830. In this example, energy storage device 830 is a torsion spring for storing potential energy. Torsion spring 830 is thus configured to provide a bias torque to shaft 806 when helical wrap spring 808 is released. The bias torque from torsion spring 830 is designed to operate upon coupling 820, which is the previously-described payload. Coupling 820 engages a lock release 822 that is configured to release safety lock 824. Safety lock 824 prevents inadvertent movement of seat back 804, especially during moments of extreme deceleration.

Vehicle seat back release mechanism 800 operates as follows. First, consider that seat back 804 is in an upright position and safety lock 824 is locked to prevent inadvertent forward or rearward movement of seat back 804. Also, torsion spring 830 has already been charged upon previously rotating seat back 804 from a forward position to the upright position in direction “charge” 832. Typically, the bias torque of torsion spring 830 is generated by human hand. This bias force causes shaft 806 to rotate against the turns of helical wrap spring 808, thereby causing helical wrap spring 808 to be in its extra wrapped state. As such, torsion spring cannot discharge while shaft 806 is in frictionally engaged.

To enter or exit rear seat, a passenger triggers or activates SMA actuator 802 to cause helical wrap spring 808 to unwrap slightly so as to release its grip on shaft 806. When helical wrap spring 808 releases shaft 806, the bias torque from torsion spring 830 causes coupling 820 to disengage lock release 822, thereby causing safety lock 824 to unlock. Since unlocking of safety lock 824 permits relative rotation between seat back 804 and shaft 806, the bias torque from torsion spring 830 does not itself affect the position of seat back 804.

When a user tilts seat back 804 in a forward direction for entry or exit, anchor member 828, which is firmly attached to seat back 804, follows along in unison. The unwrapping action expected primarily at spring end 808b, however slight, permits a relative rotation of both seat back 804 and helical wrap spring 808 about shaft 806, which remains stationary. Although SMA actuator 802 can be typically inactive with its output drive member relaxed or extended during the forward movement of seat back 804, SMA actuator 802 can optionally be activated to reduce friction with shaft 806.

Next, when a user again brings seat back 804 to an upright position, the wrapping action of the coil of helical wrap spring 808 at end 808b causes it to frictionally engage shaft 806. SMA actuator is unpowered during the return of seat back 804 to its upright position. So, as seat back 804 continues moving to its upright position, shaft 806 transfers torque to recharge torsion spring 830. Then, coupling 820 returns to its initial state of engaging lock release 822. Once seat back 804 is returned it its upright position, safety lock 824 moves in direction “reset” 826 to again lock seat back 804 against inadvertent seat back movement.

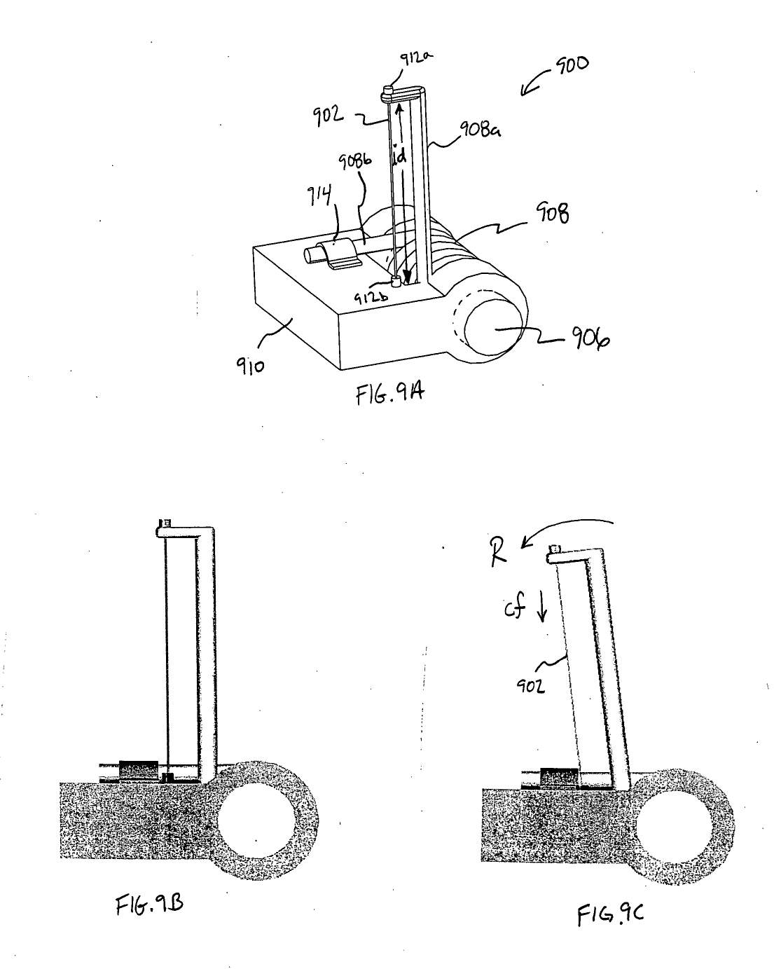

FIGS. 9A to 9C illustrate a bender-actuated helical spring brake in accordance with an embodiment of the present invention. Helical wrap spring 908 has a first spring end 908a configured to extend as a lever arm, and also has a second spring end 908b immovably secured at anchor point 914, which is affixed to support 910. Support 910 provides general support for shaft 906 so that it can rotate. Further, support 910 can internally include electrical and mechanical mechanisms (not shown) to power actuator 902. Actuator 902 can include one or more actuation elements composed of SMA wires and/or bender actuators. Insulators 912a and 912b allow actuator 902 to remain electrically and mechanically isolated from support 910. FIG. 9B shows actuator 902 in one state and FIG. 9C shows actuator 902 in another state, such as its active state. That is, when actuator 902 contracts in the direction of retraction force, “cf,” first spring end 908a moves in direction “R.”

Bender actuators are well known and are constructed from any of several technologies, such as piezoelectric, bi-metal (thermally bendable), as well as SMA actuators. Bender actuators typically consist of two elongated members joined mechanically either at both ends, or entirely along their common length. Generally, the two members differ in their responsiveness to external stimuli. For instance, in a piezoelectric bender actuator, one member can be a piece of active ceramic whereas the other is a passive element. The passive element can be any of the following: a passive ceramic, a passive metal, or an active ceramic, but with opposite sign of responsiveness. When an appropriate stimulus is applied to a bender actuator as actuator 902, bender actuator either bends or tilts (i.e., does not necessarily contract or expand linearly). For example, if actuator 902 is a bender actuator, then it has one end fixed to support 910 via insulator 912b. The other end of actuator 902 is coupled to first spring end 908a via insulator 912a. As such, the bender actuator is able to perform mechanical work, even though it can generate forces along a curved path that is generally perpendicular to the long direction of actuator 902. Conceptually, first spring end 908a of actuator 902 can be viewed as being part of actuator 902, when configured as a bender actuator.

Regardless, the bending action inherent in bender actuators works by deflecting the movable end (i.e., first spring end 908a) in a direction that unwraps the coil of helical wrap spring 908. This action advantageously includes both an angular tilt component and a small tangential translation component of first spring end 908a. Both of these components work in the direction of unwrapping helical wrap spring 908. The balance between the tilt and translation components depends on the initial distance, “id,” from a connection point associated with insulator 912b to a connection point associated with insulator 912a. The availability of both of these components means that distance “id” need not be set with excessively tight tolerance. This, in turn, makes the manufacturability of products more forgiving of assembly inaccuracies.

The foregoing description, for purposes of explanation, used specific nomenclature to provide a thorough understanding of the invention. However, it will be apparent to one skilled in the art that specific details are not required in order to practice the invention. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. Any feature of any specific embodiment of the present invention can be employed in any embodiment described herein. It is intended that the following claims and their equivalents define the scope of the invention.

1. A shape memory alloy (“SMA”)-actuated helical spring brake comprising:
a rotatable member;
a helical spring brake having a first spring end and a second spring end; and
an SMA actuator having an output drive member coupled to said first spring end and configured to deflect said first spring end to permit said rotatable member to rotate,
wherein said SMA actuator is configured to
retract said output drive member to move said first spring end from a first position to a second position when sufficient power is applied to said SMA actuator, and to
extend said output drive member as said first spring end moves from said second position to said first position when power is removed from said SMA actuator.

2. The SMA-actuated helical spring brake of claim 1 wherein said helical spring brake comprises:
a helical wrap spring arranged concentrically about said rotatable member and having said first spring end and said second spring end, said helical wrap spring including a number of turns that are biased radially inward and are configured to frictionally engage said rotatable member, said turns permitting rotation of said rotatable member in a first direction and inhibiting rotation in a second direction; and
an anchor point coupled to said second spring end.

3. The SMA-actuated helical spring brake of claim 1 further comprising a trigger to generate an electrical signal for a predetermined duration that causes said SMA actuator to contract by heating one or more SMA elements.

4. The SMA-actuated helical spring brake of claim 3 wherein said trigger is configured to require less physical effort by a user than a mechanically-actuated helical spring brake.

5. The SMA-actuated helical spring brake of claim 2 further comprising a deflection detector configured to detect said first spring end moving from a first position to a second position, wherein at said first position said helical wrap spring is frictionally engaged with said rotatable member and at said second position said helical wrap spring permits said rotatable member to rotate in either direction.

6. The SMA-actuated helical spring brake of claim 5 wherein said deflection detector is further configured to deactivate said SMA actuator to increase longevity of said SMA actuator upon detecting said second position.

7. The SMA-actuated helical spring brake of claim 2 further comprising a rotation detector configured to detect whether said rotatable member is rotating.

8. The SMA-actuated helical spring brake of claim 7 wherein said rotation detector is configured to stop said output drive member from retracting to increase longevity of said SMA actuator upon detecting that said rotatable member stops rotating.

9. The SMA-actuated helical spring brake of claim 7 wherein said rotation detector is configured to control the rotation of said rotatable member at a relatively steady rate of rotation.

10. The SMA-actuated helical spring brake of claim 2 further comprising:
a motor rigidly coupled to said rotatable member for providing a motive torque to rotate said rotatable member; and
a payload rigidly coupled to said rotatable member.

11. The SMA-actuated helical spring brake of claim 10 further comprising an end-of-travel switch configured to detect an end-of-travel position for said payload and to deactivate said SMA actuator upon detecting said end-of-travel position to increase longevity of said SMA actuator.

12. The SMA-actuated helical spring brake of claim 10 wherein said payload has a bias force sufficient to rotate said rotatable member in said second direction when said helical wrap spring permits said rotatable member to rotate.

13. The SMA-actuated helical spring brake of claim 12 wherein said payload is a window.

14. The SMA-actuated helical spring brake of claim 10 further comprising a biasing device configured to induce rotation of said rotatable member in said second direction when said helical wrap spring permits said rotatable member to rotate.

15. The SMA-actuated helical spring brake of claim 14 wherein said payload is either a pin of a pin-latch mechanism or a door of a door-moving mechanism.

16. A shape memory alloy (“SMA”)-actuated system for imparting motion to a payload comprising:
a rotatable member configured to cause said payload to move; and
an SMA-actuated helical spring brake in frictional engagement with said rotatable member when said SMA-actuated helical spring brake is inhibiting rotation of said rotatable member in at least one direction, thereby preventing movement of said payload in said at least one direction,
wherein said SMA-actuated helical spring brake is configured to release said rotatable member to freely rotate when power is applied to sufficiently contract one or more SMA elements of said SMA-actuated helical spring brake.

17. The SMA-actuated system of claim 16 wherein said SMA-actuated system is a window lifter mechanism and said payload is a window.

18. The SMA-actuated system of claim 17, further comprising a motor configured to rotate said rotatable member in said at least one direction.

19. The SMA-actuated system of claim 17, wherein a bias force generated by the weight of said window causes said rotatable member to rotate when said SMA-actuated helical spring brake is released.

20. The SMA-actuated system of claim 16 wherein said SMA-actuated system is a pin-latch mechanism for detaching two or members and further comprises:
a first member and a second member;
a latch affixed to said first member;
a pin pivotally coupled to said rotatable member, said pin being said payload and configured to engage said latch to join said first member to said second member; and
a bias device configured to maintain a bias force on said rotatable member,
wherein said SMA-actuated helical spring brake is configured to release said rotatable member so that said bias force can disengage said pin from said latch.

21. The SMA-actuated system of claim 20, wherein said rotatable member rotates when power is applied to sufficiently contract one or more SMA elements of said SMA-actuated helical spring brake.

22. The SMA-actuated system of claim 16 wherein said SMA-actuated system is a vehicle seat back release mechanism for permitting and inhibiting movement in relation to a seat bottom, said system further comprising:
a vehicle seat back rigidly coupled to an SMA-actuated helical spring brake and locked in an upright position;
a coupling rigidly coupled to said rotatable member; and
a safety lock configured to unlock said vehicle seat back in response to movement of said coupling,
wherein said coupling moves when said SMA-actuated helical spring brake is released.

23. The SMA-actuated system of claim 22 further comprising a trigger for actuating said SMA-actuated helical spring brake to unlock said safety lock, wherein said trigger is remotely located from and is in electrical communication with said SMA-actuated helical spring brake.

24. The SMA-actuated system of claim 22 wherein said SMA-actuated helical spring brake comprises:
a helical wrap spring arranged concentrically about said rotatable member and having a first spring end and a second spring end, said helical wrap spring including a number of turns that are biased radially inward and are configured to frictionally engage said rotatable member, said turns permitting rotation of said rotatable member in a first direction and inhibiting rotation of said rotatable member in a second direction; and
an anchor member having a first anchor point coupled to said second spring end and a second anchor point rigidly coupled to said vehicle seat back,
wherein, said SMA actuator is rigidly coupled to said vehicle seat back.

25. The SMA-actuated system of claim 22, further comprising an energy storage device that
stores energy when rotation of said rotatable member is inhibited, and
imparts a bias force onto said rotatable member for moving said coupling when rotation of said rotatable member is permitted.

26. The SMA-actuated system of claim 25, wherein said SMA-actuated helical spring brake and said vehicle seat back are configured to rotate about said rotatable member as said vehicle seat back moves from said upright position to a forward position, said SMA-actuated helical spring brake being configured to also frictionally engage said rotatable member as said vehicle seat back moves from said forward position to said upright position to rotate said rotatable member, thereby storing energy in said energy storage device.

27. A bender-actuated helical spring brake comprising:
a rotatable member;
a support configured to guide rotation of said rotatable member;
a helical wrap spring having a first spring end and a second spring end, said helical wrap spring including a number of turns that are biased radially inward and configured to frictionally engage said rotatable member, said turns permitting rotation of said rotatable member in a first direction and inhibiting rotation of said rotatable member in a second direction;
a support coupled to said second spring end; and
a bender actuator having a first end coupled to said first spring end and configured to deflect said first spring end to permit said rotatable member to rotate,
wherein said bender actuator generates a contraction force in a nonaxial direction to that of said bender actuator.

28. The bender-actuated helical spring brake of claim 27 wherein said bender actuator includes one or more of the following: a piezoelectric ceramic element, a bi-metal element and an SMA element.

29. The bender-actuated helical spring brake of claim 27 wherein the behavior of said bender actuator to actuate in said nonaxial direction compensates for manufacturing anomalies.

30. A method for actuating a shape memory alloy (“SMA”) helical spring brake for imparting motion to a payload comprising:
powering an SMA actuator by applying electrical current to one or more SMA elements therein;
retracting an output drive member of said SMA actuator;
deflecting a spring end of a helical wrap spring to permit a rotatable member to rotate; and
moving said payload in response to said rotatable member rotating,
wherein said SMA actuator is powered for a predetermined duration of time to increase longevity of said SMA actuator.

31. The method of claim 30 wherein deflecting said spring end further comprises:
detecting that said output drive member is at an end-of-travel position; and
removing power from said SMA actuator.

32. The method of claim 30 wherein moving said payload further comprises:
detecting that said payload is at an end-of-travel position; and
removing power from said SMA actuator.

33. The method of claim 30 further comprising:
triggering activation of said SMA helical spring brake; and
electrically communicating said activation to power said SMA actuator.
